(19) United States
(12) Patent Application Publication
(10) Pub. No.: US 2025/0233630 A1
(43) Pub. Date: Jul. 17, 2025

(54) METHODS AND APPARATUS FOR CSI REPORTING ON MULTI-PANEL PUSCH

(71) Applicant: APPLE INC., Cupertino, CA (US)

(72) Inventors: Yushu Zhang, Beijing (CN); Dawei Zhang, Saratoga, CA (US); Weidong Yang, San Diego, CA (US); Chunxuan Ye, San Diego, CA (US); Seyed Ali Akbar Fakoorian, San Diego, CA (US); Huaning Niu, San Jose, CA (US); Hong He, San Jose, CA (US); Haitong Sun, Cupertino, CA (US); Wei Zeng, Saratoga, CA (US)

(21) Appl. No.: 18/853,611

(22) PCT Filed: Mar. 23, 2023
(86) PCT No.: PCT/US2023/064859

§ 371 Date: Oct. 2, 2024

Related U.S. Application Data
(60) Provisional application No. 63/363,079, filed on Apr. 15, 2022.

(51) Int. Cl. H04B 7/06; H04W 24/10; H04W 72/1268

(52) U.S. Cl. CPC H04B 7/0626; H04W 24/10; H04W 72/1268

(57) ABSTRACT

A user equipment (UE) is configured for multi-panel physical uplink shared channel (PUSCH) transmission using multiple antenna panels. The UE may send a UE capability message to a base station to indicate a plurality of channel state information (CSI) report schemes supported by the UE. The UE processes a signal from the base station to configure the UE for a selected CSI report scheme of the plurality of CSI report schemes. The UE determines whether one or more condition associated with the selected CSI report scheme is satisfied. The UE transmits, to the base station, CSI in one or more PUSCH from one or more of the multiple antenna panels based on whether the one or more condition associated with the selected CSI report scheme is satisfied.

### TECHNICAL FIELD

This application relates generally to wireless communication systems, including channel state information (CSI) reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates example timing diagrams of the first scheme for CSI reporting over PUSCH that may be used in accordance with one embodiment.

FIG. 1B illustrates example timing diagrams of the second scheme for CSI reporting over PUSCH that may be used in accordance with one embodiment.

FIG. 2 illustrates aperiodic CSI reporting wherein base station scheduling attempts to follow a minimal Z and Z′ requirement in accordance with one embodiment.

FIG. 3 illustrates example multiplexing schemes for multi-panel based PUSCH transmission in accordance with one embodiment.

FIG. 4 illustrates example CSI report schemes in accordance with one embodiment.

FIG. 5 illustrates a method for a UE in accordance with one embodiment.

FIG. 6 illustrates a method for a base station in accordance with one embodiment.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In certain wireless communication systems (e.g., 3GPP Release 17 (Rel-17)), a physical uplink shared channel (PUSCH) may be transmitted in N repetitions based on M beams (e.g., M=1 or 2). The N repetitions may be multiplexed in time division multiplexing (TDM) manner. The beams and repetitions may be mapped in a cyclic or sequential manner.

Two schemes for CSI reporting over PUSCH may be supported. In a first scheme (Scheme 1), the UE reports CSI to the base station in a first PUSCH repetition. In a second scheme (Scheme 2), the UE reports CSI to the base station in first PUSCH repetition for each beam. Scheme 2 may be enabled by radio resource control (RRC) signaling and may be used to report aperiodic or semi-persistent CSI when the time domain duration for both PUSCH repetitions with the CSI are the same and no other uplink control information is multiplexed. For semi-persistent CSI reporting over PUSCH, in certain implementations, N is equal to two.

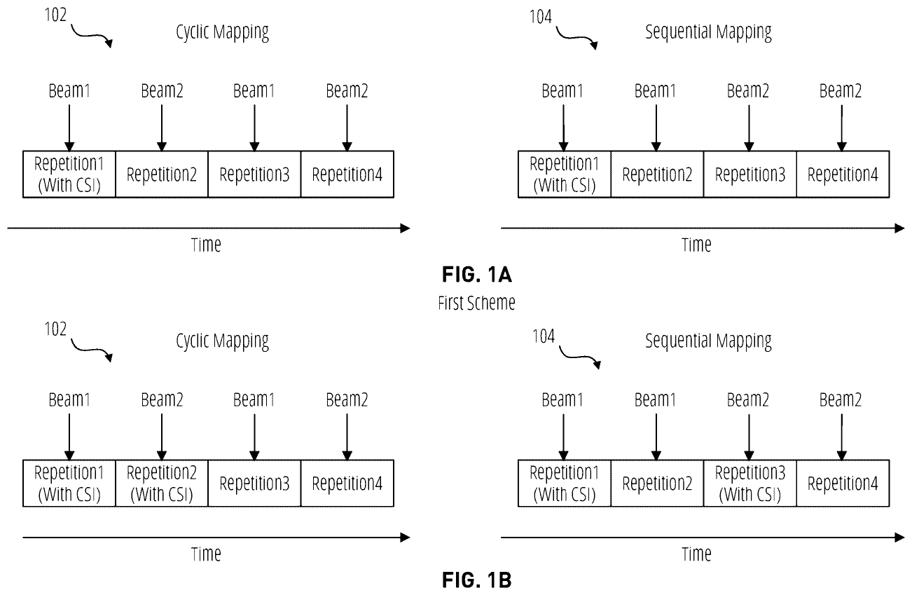

FIG. 1A illustrates example timing diagrams of the first scheme for CSI reporting over PUSCH that may be used according to certain embodiments. FIG. 1B illustrates example timing diagrams of the second scheme for CSI reporting over PUSCH that may be used according to certain embodiments.

Both FIG. 1A and FIG. 1B show examples of cyclic mapping 102 and sequential mapping 104. In cyclic mapping 102, the beams (e.g., Beam1 and Beam2) alternate between being mapped to subsequent repetitions (e.g., Repetition1, Repetition2, Repetition3, and Repetition4). For example, the first beam (Beam1) is mapped to the first repetition (Repetition1) and the second beam (Beam2) is mapped to the second repetition (Repetition2), then the first beam (Beam1) is mapped to the third repetition (Repetition3) and the second beam (Beam2) is mapped to the fourth repetition (Repetition4). In sequential mapping 104, the first beam (Beam1) is mapped to sequential repetitions (Repetition1 and Repetition2) before the second beam (Beam2) is mapped to subsequent sequential repetitions (Repetition3 and Repetiton4).

In the first scheme, as shown in FIG. 1A, the UE transmits the CSI in the first repetition (Repetition1). That is to say, the UE reports the CSI in the first repetition (Repetition1) for both beams (Beam1 and Beam2).

In the second scheme, as shown in FIG. 1B, the UE transmits CSI in the first repetition corresponding to each beam. Thus, for the cyclic mapping 102 under the second scheme, the UE reports CSI for the first beam (Beam1) in the first repetition (Repetition1), and the UE reports CSI for the second beam (Beam2) in the second repetition (Repetition2). Whereas for the sequential mapping 104 under the second scheme, the UE reports CSI for the first beam (Beam1) in the first repetition (Repetition1), and the UE reports CSI for the second beam (Beam2) in the third repetition (Repetition3) (i.e., the first repetition corresponding to the second beam).

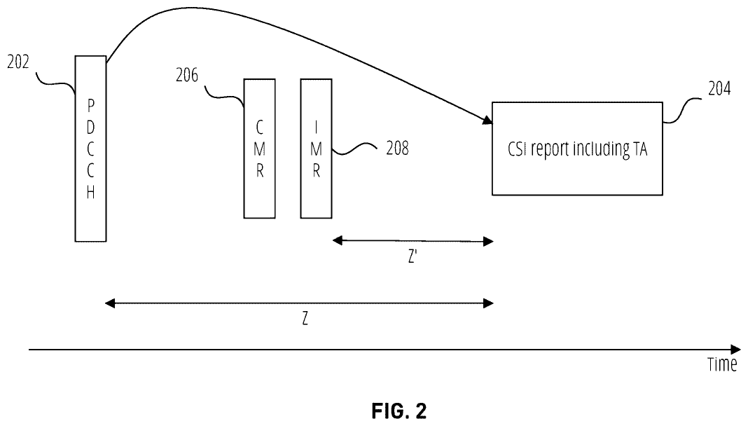

FIG. 2 illustrates aperiodic CSI reporting, wherein base station scheduling attempts to follow a minimal Z and Z′ requirement according to certain embodiments. In this example, the relative timing of a physical downlink control channel (PDCCH) 202 is shown with respect to a CSI report 204 including a timing advance (TA). Skilled persons will recognize from the disclosure herein that the PDCCH 202 may trigger the CSI report 204. Z is defined as the offset between a last symbol of the PDCCH 202 and a first symbol of the CSI report 204 including TA. Z′ is defined as the offset between a last symbol of a channel measurement resource (CMR) 206 and an interference measurement resource (IMR) 208 and the first symbol of CSI report 204 including TA. If the base station schedules a CSI report with a smaller offset than the minimal value of Z and/or Z′, the UE may report an outdated CSI.

In 3GPP Rel-15 and 3GPP Rel-16, a CSI processing unit (CPU) may be used (see, e.g., Technical Specification (TS) 38.214, section 5.2.1.6), wherein a UE indicates the number of supported simultaneous CSI calculations N_{CPU}. If a UE supports NCPU simultaneous CSI calculations, it is said to have Ncpu CSI processing units for processing CSI reports across configured cells. If L CPUs are occupied for calculation of CSI reports in a given OFDM symbol, the UE has NCPU-L unoccupied CPUs. A UE can process one or more than one CSI measurement and report, which is based on UE capability of number of CPUs.

A CPU occupancy rule may be defined as follows (for a CSI report with reportQuantity not set to “none”). A periodic or semi-persistent CSI report (excluding an initial semi-persistent CSI report on PUSCH after the PDCCH triggering the report) occupies CPU(s) from the first symbol of the earliest one of each CSI reference signal (CSI-RS), CSI interference measurement (CSI-IM), and/or synchronization signal block (SSB) resource for channel or interference measurement, respective latest CSI-RS/CSI-IM/SSB occasion no later than the corresponding CSI reference resource until the last symbol of the configured PUSCH or physical uplink control channel (PUCCH) carrying the report.

An aperiodic CSI report occupies CPU(s) from the first symbol after the PDCCH triggering the CSI report until the last symbol of the scheduled PUSCH carrying the report.

An initial semi-persistent CSI report on PUSCH after the PDCCH trigger occupies CPU(s) from the first symbol after the PDCCH until the last symbol of the scheduled PUSCH carrying the report.

In 3GPP Rel-18, simultaneous multi-panel based PUSCH transmission may be used, in which a UE may transmit multiple PUSCHs simultaneously using multiple antenna panels. The PUSCHs may be multiplexed using frequency domain multiplexing (FDM), spatial domain multiplexing (SDM), or hybrid FDM/SDM/TDM manner. The PUSCHs may be scheduled by a single downlink control information (DCI) or multiple DCIs. For multi-DCI (mDCI) based operation, each DCI schedules one PUSCH.

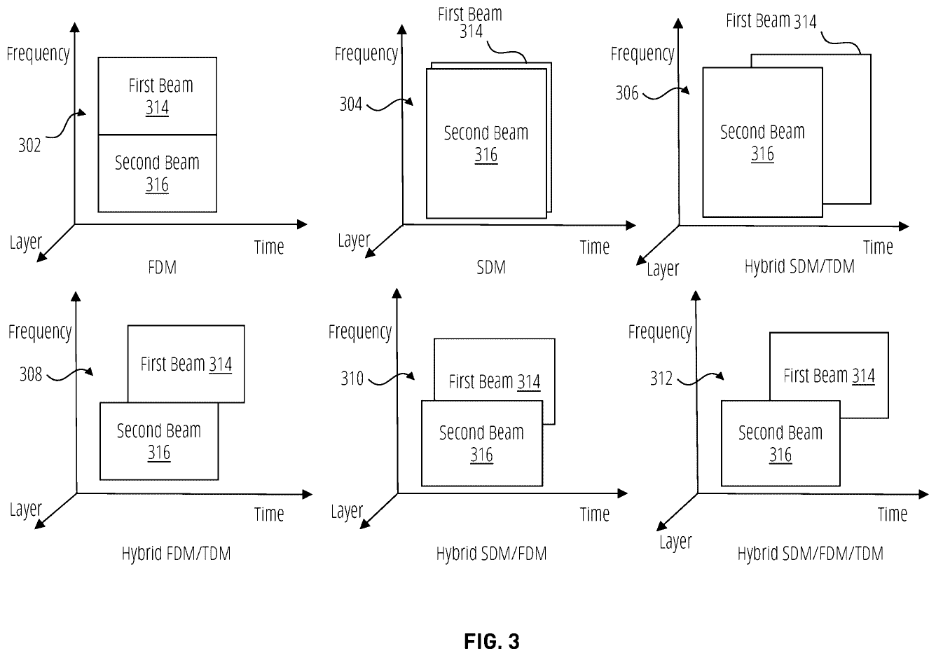

For example, FIG. 3 illustrates example multiplexing schemes for multi-panel based PUSCH transmission according to certain embodiments. An FDM scheme 302 separates resources for a first beam 314 and a second beam 316 by frequency. An SDM scheme 304 separates resources for the first beam 314 and the second beam 316 by spatial layer. A hybrid SDM and TDM scheme 306 separates resources for the first beam 314 and the second beam 316 by both spatial layer and time. A hybrid FDM and TDM scheme 308 separates resources for the first beam 314 and the second beam 316 by both frequency and time. A hybrid SDM and FDM scheme 310 separates resources for the first beam 314 and the second beam 316 by both spatial layer and frequency. A hybrid SDM, FDM, and TDM scheme 312 separates resources for the first beam 314 and the second beam 316 by spatial layer, frequency, and time.

Embodiments disclosed herein include methods to support CSI reporting on multi-panel based PUSCH. In certain embodiments, CSI report schemes and control signaling are provided for CSI report scheme selection. In addition, or in other embodiments, a definition is provided for minimal CSI processing delay. In addition, or in other embodiments, a CPU occupancy rule is provided.

### CSI Report Schemes

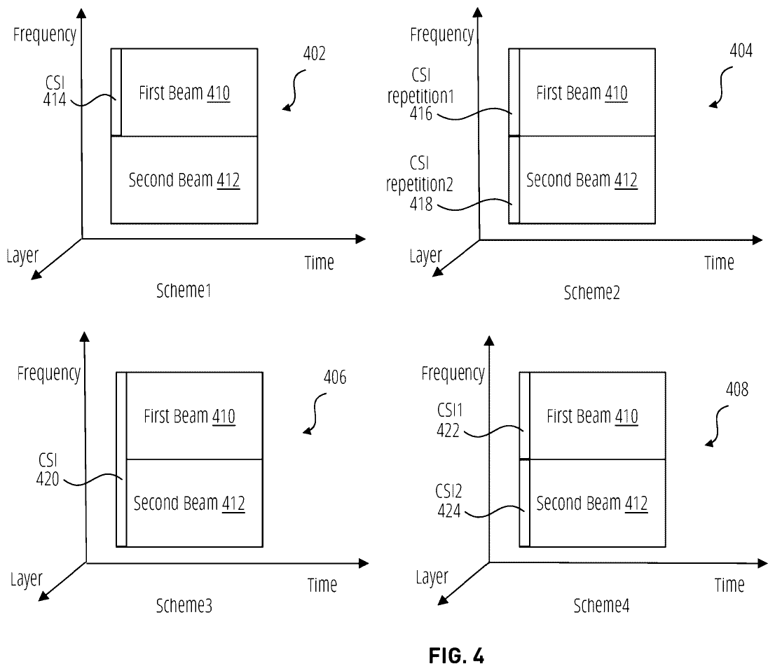

FIG. 4 illustrates example CSI report schemes according to certain embodiments. In a first CSI report scheme 402 (Scheme1), a UE reports CSI from PUSCH from a single antenna panel or beam. In the illustrated example for first CSI report scheme 402, a first beam 410 includes CSI 414 and a second beam 412 does not.

In a second CSI report scheme 404 (Scheme2), the UE reports CSI as N repetitions in N PUSCHs from N antenna panels or beams. Each CSI repetition is reported in one PUSCH from one panel or beam. In the illustrated example for second CSI report scheme 404, the first beam 410 includes CSI first repetition 416 (CSI repetition1) and the second beam 412 includes CSI second repetition 418 (CSI repetition2).

In a third CSI report scheme 406 (Scheme3), the UE reports CSI as one repetition in N PUSCHs from N panels or beams. In the illustrated example for third CSI report scheme 406, CSI 420 is included in both the first beam 410 and the second beam 412.

In a fourth CSI report scheme 408 (Scheme4), the UE reports different CSI in different PUSCHs, wherein each CSI is reported in one PUSCH from one panel or beam. In this scheme, X (X<=N) CSIs can be reported in N PUSCHs. In the illustrated example for fourth CSI report scheme 408, the first beam 410 includes first CSI 422 (CSI1) and the second beam 412 includes second CSI 424 (CSI2).

In certain embodiments, all four of the CSI report schemes may be supported. In other embodiments, only a subset of the CSI report schemes are supported (i.e., only one or more of the schemes are supported).

In certain embodiments, a PUSCH transmitted from a single configured-grant may reuse the same operation as a single-DCI based PUSCH, and a PUSCH transmitted from a multiple configured-grant may reuse the same operation as multi-DCI based PUSCH. In certain such embodiments, each configured-grant is assumed to be associated with one transmission-reception point (TRP), e.g., control resource set (CORESET) pool index (i.e., CORESETPoolIndex).

In certain embodiments, the solutions disclosed herein for the CSI report can be extended for a HARQ-ACK report.

### CSI Report Scheme Selection

In certain embodiments, the UE reports its supported CSI report scheme(s) as a UE capability to a base station (e.g., gNB). Based on the reported UE capability, the base station configures the CSI report scheme(s) using higher layer signaling (e.g., RRC signaling).

In certain embodiments, one or more CSI report schemes may only be enabled under certain conditions. If the conditions are not met when the UE is configured with particular CSI report scheme, the UE may fallback to use a predetermined CSI report scheme (e.g., the first CSI report scheme) or the UE does not report CSI using multi-panel based PUSCH.

In certain embodiments, a subset of or all of the following seven conditions may be used for the second CSI report scheme, the third CSI report scheme, and the fourth CSI report scheme.

A first condition is that the duration of the corresponding PUSCH transmission occasions with CSI is the same.

A second condition is that the frequency domain resource for the corresponding PUSCH transmission occasions with CSI is the same.

A third condition is that in addition to CSI, no other uplink control information (UCI) is multiplexed.

A fourth condition is based on the PUSCH multiplexing scheme. For example, the CSI report scheme may only be applicable to some PUSCH multiplexing scheme(s).

A fifth condition is based on the scheduling operation (i.e., whether the PUSCHs are scheduled by a single DCI or multiple DCIs). For example, the third CSI report scheme may only be applicable for single-DCI based PUSCH, whereas the fourth CSI report scheme may only be applicable for multi-DCI based PUSCH.

A sixth condition is based on the transport block (TB) transmission scheme (i.e., whether the PUSCHs are used to carry one TB or TB repetitions). In one example, the second CSI report scheme may only be applicable if the PUSCHs are used to carry TB repetitions.

A seventh condition is based on the time domain reporting type (i.e., aperiodic and semi-persistent). In one example, the fourth CSI report scheme may only be applicable for semi-persistent CSI report.

### First CSI Report Scheme Example Embodiments

As discussed above, in the first CSI report scheme, the UE reports CSI in PUSCH from a single antenna panel or beam.

For single-DCI based multi-panel PUSCH under the first CSI report scheme, one or more of the following options may be used for PUSCH selection for CSI reporting: the PUSCH corresponding to the first or last indicated transmission configuration indicator (TCI) is selected; the PUSCH corresponding to the TCI with the lowest or highest identifier (ID) is selected; the PUSCH that starts earlier is selected; the PUSCH that is transmitted in the lowest or highest frequency location is selected; the PUSCH selection is indicated from the base station to the UE by DCI; CSI reporting may be carried on the PUSCH with lower or higher modulation and coding scheme (MCS) of PUSCH (e.g., to either minimize the CSI overhead or establish a better link with improved performance); and/or CSI reporting may be carrier on the uplink (UL) transmission without power limitation and power scaling (e.g., if two different PUSCH transmissions are not power-limited, the other options above may be used to determine the PUSCH selection).

For multi-DCI based multi-panel PUSCH under the first CSI report scheme, one or more of the following options may be used for PUSCH selection for CSI reporting: the PUSCH corresponding to the first or last control resource set (CORESET) pool index (i.e., CORESETPoolIndex) is selected (e.g., the CORESETPoolIndex may be configured per CORESET to imply the TRP index); the PUSCH corresponding to the TCI with lowest or highest ID is selected; the PUSCH that starts earlier is selected; the PUSCH that is transmitted in the lowest or highest frequency location is selected; the PUSCH with scheduling PDCCH that starts (or ends) earlier (or later) is selected; the PUSCH with the smallest Z and/or Z′ or the largest Z and/or Z′ is selected (e.g., see discussion of FIG. 2); and/or the PUSCH selection is indicated from the base station to the UE by DCI.

In one embodiment for rate matching of the CSI reported in PUSCH under the first CSI report scheme, the rate matching operation (see, e.g., TS 38.212, section 6.3.2.4.1.1) is based on the PUSCH transmission occasion with the CSI. This assumes N PUSCH transmission occasions can carry N repetitions for one TB or different TBs with the same TB size. In another embodiment, the rate matching operation is based on all the PUSCH transmission occasions to carry one TB including the one with the CSI report, which assumes N PUSCH transmission occasions can carry one TB.

In certain embodiments, Z and Z′ (e.g., see discussion of FIG. 2) are counted based on the first symbol of the PUSCH transmission occasion with a CSI report. Alternatively, Z and Z′ may be counted based on the first symbol of whole PUSCH.

In certain embodiments, the CPU is occupied until the last symbol of the PUSCH transmission occasion with CSI report. Alternatively, the CPU may be occupied until the last symbol of the whole PUSCH.

### Second CSI Report Scheme Example Embodiments

As discussed above, in the second CSI report scheme, the UE reports CSI as N repetitions in N PUSCHs from N antenna panels or beams. Each CSI repetition is reported in one PUSCH from one panel or beam.

In certain embodiments, for rate matching for the CSI repetitions under the second CSI report scheme, the number of coded bits is the same in different CSI repetitions to support soft combining. The number of coded bits for the CSI may be defined, for example, in 3GPPP TS 38.212, section 6.3.2.4.1.1. If the number of coded bits is different (e.g., due to different coding rate in different PUSCH transmission occasions with CSI report), the UE may fallback to use the first CSI report scheme to report CSI or the UE may not report CSI.

In certain embodiments, for single-DCI based operation under the second CSI report scheme, the Z and Z′ (e.g., see discussion of FIG. 2) are counted based on the first symbol of the PUSCH transmission occasion with CSI report that starts earlier. The CPU may be occupied until the last symbol of the PUSCH transmission occasion with CSI report. Alternatively, the CPU may be occupied until the last symbol of the whole PUSCH.

In certain embodiments, for multi-DCI based operation, the Z and Z′ are counted based on the last symbol of the DCI that ends later and the first symbol of the PUSCH transmission occasion with CSI report that starts earlier. The CPU may be occupied from the DCI that starts earlier until the last symbol of the PUSCH transmission occasion with CSI report. Alternatively, the CPU may be occupied until the last symbol of the whole PUSCH.

### Third CSI Report Scheme Example Embodiments

As discussed above, in the third CSI report scheme, the UE reports CSI as one repetition in N PUSCHs from N panels or beams.

In certain embodiments using the third CSI report scheme, rate matching for the CSI is determined by the PUSCHs with the CSI report. In one such embodiment, the number of coded bits is determined by the sum of coded bits calculated based on each PUSCH. In another embodiment, the number of coded bits is determined based on the rate matching operation across the PUSCHs, which may be applicable for PUSCHs with a single TB.

In certain embodiments using the third CSI report scheme, the Z and Z′ (e.g., see discussion of FIG. 2) are counted based on the first symbol of the PUSCH transmission occasion with CSI report. Alternatively, Z and Z′ may be counted based on the first symbol of whole PUSCH.

In certain embodiments using the third CSI report scheme, the CPU is occupied until the last symbol of the PUSCH transmission occasion with CSI report. Alternatively, the CPU may be occupied until the last symbol of the whole PUSCH.

### Fourth CSI Report Scheme Example Embodiments

As discussed above, in the fourth CSI report scheme, the UE reports different CSI in different PUSCHs, wherein each CSI is reported in one PUSCH from one panel or beam. X CSIs can be reported in N PUSCHs, wherein X≤N.

In certain embodiments, for single-DCI based operation under the fourth CSI report scheme, the selected PUSCH with beam, panel, and/or TCI (e.g., first or second TCI) for each CSI can be configured by the base station (e.g., gNB). In one such embodiment, the PUSCH selection is configured in a CSI report configuration (i.e., CSI-reportConfig) information element (IE). For reported CSI for a corresponding CSI-reportConfig, UE reports the CSI at a PUSCH with a corresponding TCI. In another embodiment, the PUSCH selection is indicated by DCI from the base station to the UE. For example, the base station may indicate the reported TCI for each triggered CSI-reportConfig by DCI.

In certain embodiments, for multi-DCI based operation under the fourth CSI report scheme, the triggered CSI is transmitted by the PUSCH triggered by a corresponding DCI. In addition, the base station may configure or indicate to the UE whether cross beam CSI report is enabled by RRC or DCI. If cross beam CSI report is enabled, the DCI with the first beam may trigger the CSI reported by PUSCH in the second beam.

In certain embodiments under the fourth CSI report scheme, the Z and Z′ (e.g., see discussion of FIG. 2) and CPU occupancy rule are defined based on the scheduled PUSCH and scheduling PDCCH.

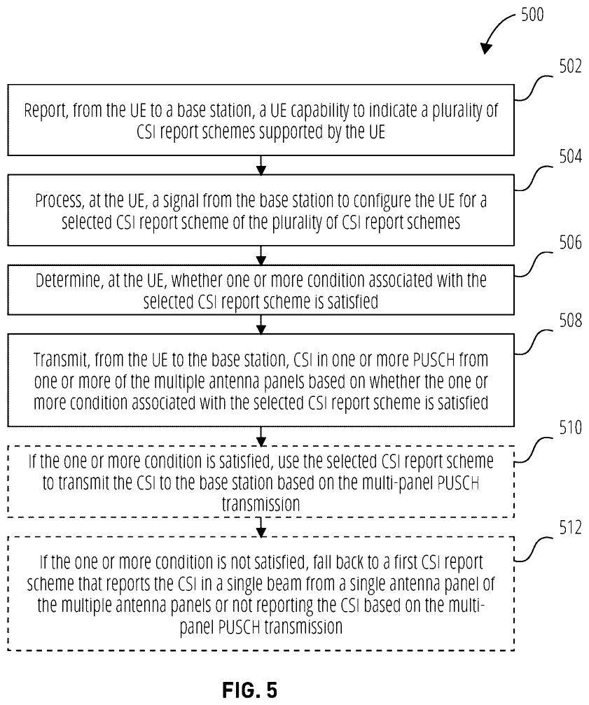

FIG. 5 is a flowchart of a method 500 for a UE configured for multi-panel PUSCH transmission using multiple antenna panels according to one embodiment. In block 502, the method 500 includes reporting, from the UE to a base station, a UE capability to indicate a plurality of CSI report schemes supported by the UE. In block 504, the method 500 includes processing, at the UE, a signal from the base station to configure the UE for a selected CSI report scheme of the plurality of CSI report schemes. In block 506, the method 500 includes determining, at the UE, whether one or more condition(s) associated with the selected CSI report scheme is satisfied. In block 508, the method 500 includes transmitting, from the UE to the base station, CSI in one or more PUSCH from one or more of the multiple antenna panels based on whether the one or more condition(s) associated with the selected CSI report scheme is satisfied.

In certain embodiments, as shown in block 510, if the one or more condition(s) is satisfied, the 500 includes using the selected CSI report scheme to transmit the CSI to the base station based on the multi-panel PUSCH transmission. In block 512, if the one or more condition(s) is not satisfied, the method 500 may include falling back to a first CSI report scheme that reports the CSI in a single beam from a single antenna panel of the multiple antenna panels or not reporting the CSI based on the multi-panel PUSCH transmission.

In certain embodiments of the method 500, the first CSI report scheme is independent of the one or more condition(s). Further, the one or more condition(s) is selected from a group comprising: a duration of the corresponding PUSCH transmission occasions with the CSI is the same; a frequency domain resource for the corresponding PUSCH transmission occasions with the CSI is the same; no uplink control information (UCI) other than the CSI is multiplexed; the selected CSI report scheme is applicable to a PUSCH multiplexing scheme configured for the UE; the selected CSI report scheme is applicable to a scheduling operation configured for the UE to schedule the one or more PUSCH; the selected CSI report scheme is applicable to a transport block (TB) transmission scheme configured for the UE to transmit the one or more PUSCH to carry one TB or TB repetitions; and the selected CSI report scheme is applicable to a time domain reporting type configured for the UE.

In certain embodiments, for the first CSI report scheme and for a single downlink control information (single-DCI) scheduling of the multi-panel PUSCH transmission, the method 500 further includes selecting a selected PUSCH for reporting the CSI based on one or more option selected from a group comprising: the selected PUSCH corresponds to a first indicated transmission configuration indicator (TCI) or a last indicated TCI; the selected PUSCH corresponds to a selected TCI with a lowest identifier (ID) or a highest ID; the selected PUSCH starts earliest; the selected PUSCH is transmitted in a lowest frequency location or a highest frequency location; the selected PUSCH is indicated to the UE from the base station by downlink control information; the selected PUSCH corresponds to a lower modulation and coding scheme (MCS) or a higher MCS; and the selected PUSCH corresponds to an uplink transmission without a power limitation and power scaling.

In certain embodiments, for the first CSI report scheme and for multiple downlink control information (multi-DCI) scheduling of the multi-panel PUSCH transmission, the method 500 further includes selecting a selected PUSCH for reporting the CSI based on one or more option selected from a group comprising: the selected PUSCH corresponds to a first control resource set (CORESET) pool index or a last CORESET pool index; the selected PUSCH corresponds to a transmission configuration indicator (TCI) with a lowest identifier (ID) or a highest ID; the selected PUSCH starts earliest; the selected PUSCH is transmitted in a lowest frequency location or a highest frequency location; the selected PUSCH corresponds to a scheduling physical downlink control channel (PDCCH) that starts earliest or ends latest; the selected PUSCH corresponds to a smallest offset Z or a smallest offset Z′, wherein the offset Z is between a last symbol of the PDCCH and a first symbol of a CSI report, and wherein the offset Z′ is between a last symbol of a channel measurement resource (CMR) or an interference measurement resource (IMR) and the first symbol of the CSI report; the selected PUSCH corresponds to a largest offset Z or a largest offset Z′; and the selected PUSCH is indicated to the UE from the base station by downlink control information.

In certain embodiments, for the first CSI report scheme and for rate matching of the CSI reported in the one or more PUSCH, the method 500 further includes performing a rate matching operation. The rate matching operation may be based on a selected PUSCH transmission occasion with a CSI report, with N PUSCH transmission occasions carrying N CSI repetitions for one transport block (TB) or different TBs with a same TB size. Alternatively, the rate matching operation is based on the N PUSCH transmission occasions to carry one TB including a selected TB with the CSI report.

In certain embodiments, for the first CSI report scheme, the method 500 further includes: determining an offset Z and an offset Z′ based on a first symbol of a PUSCH transmission occasion with a CSI report, wherein the offset Z is between a last symbol of a physical downlink control channel (PDCCH) and the first symbol of the PUSCH transmission occasion with the CSI report, and wherein the offset Z′ is between a last symbol of a channel measurement resource (CMR) or an interference measurement resource (IMR) and the first symbol of the PUSCH transmission occasion with the CSI report; or determining the offset Z and the offset Z′ based on a first symbol of the multi-panel PUSCH.

In certain embodiments of the method 500, for the first CSI report scheme: a CSI processing unit (CPU) is occupied until a last symbol of a PUSCH transmission occasion with a CSI report; or the CPU is occupied until a last symbol of the multi-panel PUSCH.

In certain embodiments of the method 500, a second CSI report scheme includes reporting the CSI as N repetitions in N PUSCHs from N antenna panels, and each of the N repetitions of the CSI is reported in one beam from one of the N antenna panels.

In certain embodiments, for the second CSI report scheme, the method 500 further includes determining a same number of coded bits for the N repetitions for rate matching to support soft combining. The same number of coded bits may be predefined.

In certain embodiments, for the second CSI report scheme, the method 500 further includes: determining a different number of coded bits for the N repetitions for rate matching; and in response to determining the different number of coded bits, falling back to a first CSI report scheme or not reporting the CSI.

In certain embodiments, for the second CSI report scheme and for a single downlink control information (single-DCI) scheduling of the multi-panel PUSCH transmission, the method 500 further includes: determining an offset Z and an offset Z′ based on a first symbol of a PUSCH transmission occasion with a CSI report that starts earlier, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion. In certain such embodiments, for the second CSI report scheme: a CSI processing unit (CPU) is occupied until a last symbol of the PUSCH transmission occasion with the CSI report; or the CPU is occupied until a last symbol of the multi-panel PUSCH.

In certain embodiments, for the second CSI report scheme and for multiple downlink control information (multi-DCI) scheduling of the multi-panel PUSCH transmission, the method 500 further includes: determining an offset Z and an offset Z′ based on a last symbol of a first DCI that ends later and a first symbol of a PUSCH transmission occasion with a CSI report that starts earlier, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion. In certain such embodiments, for the second CSI report scheme: a CSI processing unit (CPU) is occupied from second DCI that starts earlier until a last symbol of the PUSCH transmission occasion with the CSI report; or the CPU is occupied until a last symbol of the multi-panel PUSCH.

In certain embodiments of the method 500, a third CSI report scheme comprises reporting the CSI as one repetition in N PUSCHs from N antenna panels.

In certain embodiments, for the third CSI report scheme, rate matching for the CSI is based on the N PUSCHs with the CSI, and the method 500 further includes: determining a number of coded bits for the rate matching as a sum of coded bits calculated based on each PUSCH; or determining the number of coded bits for the rate matching based on a rate matching operation across the N PUSCHs.

In certain embodiments, for the third CSI report scheme, the method 500 further includes: determining an offset Z and an offset Z′ based on a first symbol of a PUSCH transmission occasion with a CSI report, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion; or determining the offset Z and the offset Z′ based on a first symbol of the multi-panel PUSCH. In certain such embodiments, for the third CSI report scheme: a CSI processing unit (CPU) is occupied until a last symbol of the PUSCH transmission occasion with the CSI report; or the CPU is occupied until a last symbol of the multi-panel PUSCH.

In certain embodiments of the method 500, a fourth CSI report scheme comprises reporting different CSI in different PUSCHs, and each CSI is reported in one PUSCH from one antenna panel.

In certain embodiments, for the fourth CSI report scheme and for a single downlink control information (single-DCI) scheduling of the multi-panel PUSCH transmission, the method 500 further includes selecting a selected PUSCH for reporting the CSI based on a configuration by the base station. Further, the selected PUSCH is: configured in a CSI report configuration (i.e., CSI-reportConfig) information element (IE) and the UE reports the CSI at the selected PUSCH with a corresponding transmission configuration indicator (TCI); or indicated by downlink control information (DCI) where the base station indicates a reported TCI for each triggered CSI-reportConfig.

In certain embodiments, for the fourth CSI report scheme and for multiple downlink control information (multi-DCI) scheduling of the multi-panel PUSCH transmission, the method 500 further includes transmitting the CSI in a selected PUSCH triggered by a corresponding downlink control information (DCI). In certain such embodiments, for the fourth CSI report scheme, the method 500 further includes: determining, at the UE by an indication or configuration by the base station, that a cross beam CSI report is enabled by radio resource control (RRC) signaling or the DCI; and in response to determining that the cross beam CSI report is enabled, determining that the DCI with a first beam triggers the CSI reported by PUSCH in a second beam.

In certain embodiments of the method 500, for the fourth CSI report scheme, a Z offset, a Z′ offset, and a CSI processing unit (CPU) occupancy rule are defined based on scheduled PUSCH and a scheduling physical downlink control channel (PDCCH), wherein the offset Z is between a last symbol of the scheduling PDCCH and a first symbol of a CSI report, and wherein the offset Z′ is between a last symbol of a channel measurement resource (CMR) or an interference measurement resource (IMR) and the first symbol of the CSI report.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

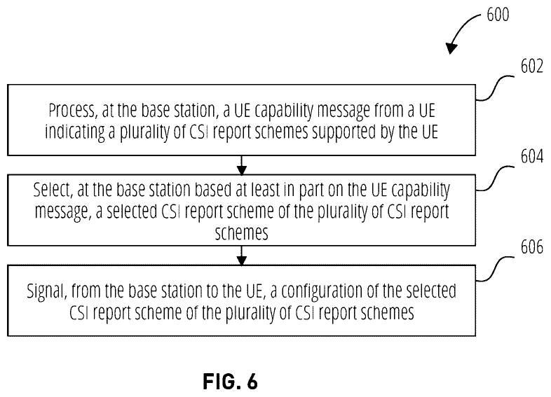

FIG. 6 is a flowchart of a method 600 for base station according to one embodiment. In block 602, the method 600 includes processing, at the base station, a UE capability message from a UE indicating a plurality of CSI report schemes supported by the UE. In block 604, the method 600 includes selecting, at the base station based at least in part on the UE capability message, a selected CSI report scheme of the plurality of CSI report schemes. In block 606, the method 600 includes signaling, from the base station to the UE, a configuration of the selected CSI report scheme of the plurality of CSI report schemes.

In certain embodiments of the method 600, the signaling comprises radio resource control (RRC) signaling.

In certain embodiments, the method 600 further includes determining, by the base station, the configuration per at least one of a CSI report configuration, a bandwidth part, a serving cell, and the UE.

In certain embodiments of the method 600, for a first CSI report scheme, CSI is reported in a single beam from a single antenna panel of the multiple antenna panels.

In certain embodiments, for the first CSI report scheme, the method 600 further comprises indicating, from the base station to the UE by downlink control information, a selected PUSCH for the UE to report the CSI.

In certain embodiments of the method 600, for a second CSI report scheme, CSI is reported as N repetitions in N PUSCHs from N antenna panels, and wherein each of the N repetitions of the CSI is reported in one beam from one of the N antenna panels.

In certain embodiments of the method 600, for a third CSI report scheme, CSI is reported as one repetition in N PUSCHs from N antenna panels.

In certain embodiments of the method 600, for a fourth CSI report scheme, different CSI is reported in different PUSCHs, and each CSI is reported in one PUSCH from one antenna panel.

In certain embodiments, for the fourth CSI report scheme and for a single downlink control information (single-DCI) scheduling of the multi-panel PUSCH transmission, the method 600 further includes configuring, by the base station, a selected PUSCH for reporting the CSI, and wherein the selected PUSCH is: configured in a CSI report configuration (i.e., CSI-reportConfig) information element (IE) for the UE to report the CSI at the selected PUSCH with a corresponding transmission configuration indicator (TCI); or indicated by downlink control information (DCI) where the base station indicates a reported TCI for each triggered CSI-reportConfig.

In certain embodiments, for the fourth CSI report scheme and for multiple downlink control information (multi-DCI) scheduling of the multi-panel PUSCH transmission, the method 600 further includes configuring downlink control information (DCI) to trigger a selected PUSCH for the UE to transmit CSI. In certain such embodiments, the method 600 further includes indicating to the UE by the base station that a cross beam CSI report is enabled by radio resource control (RRC) signaling or the DCI.

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

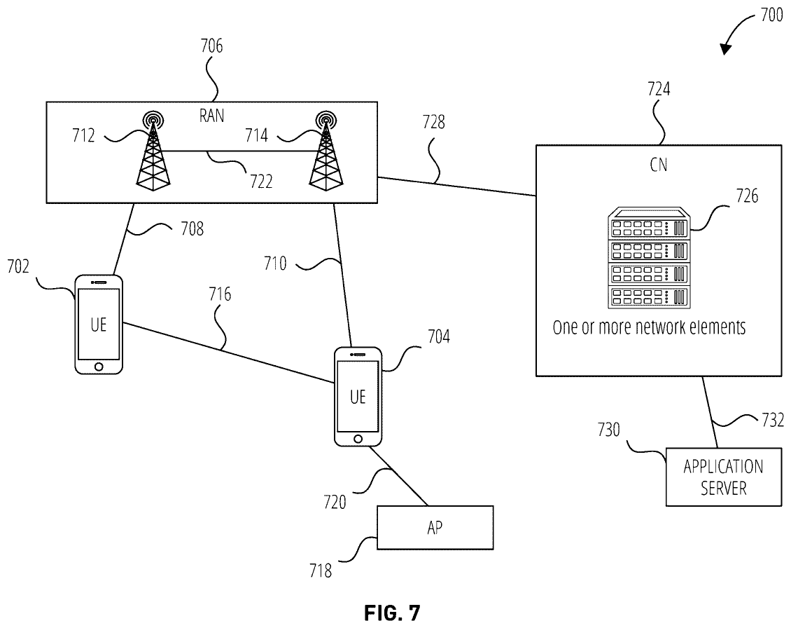

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the SI interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

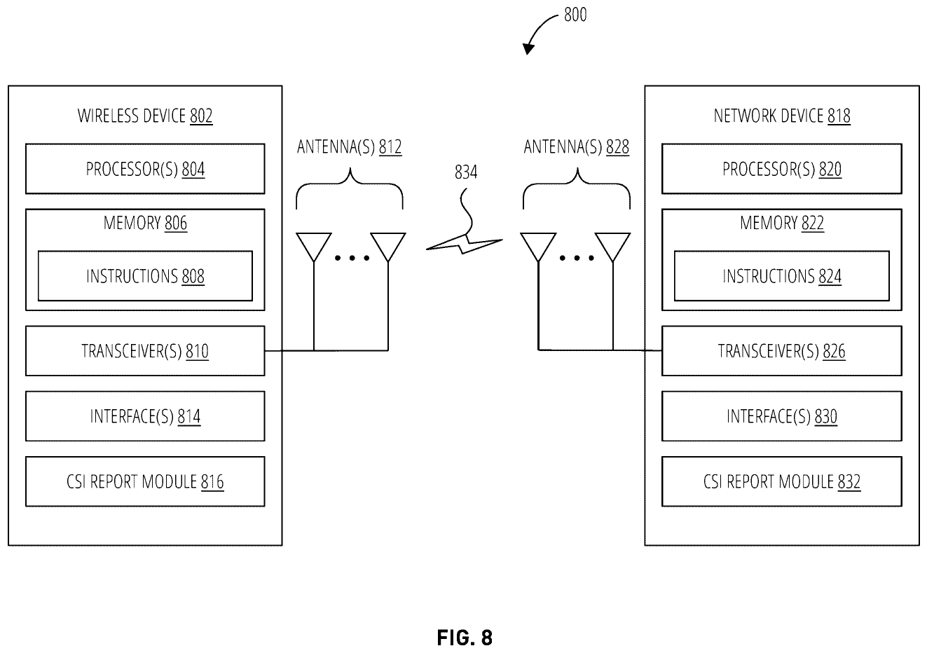

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit, a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more), which may also be referred to herein as antenna panels or simply panels. For embodiments with multiple antenna(s) 812 (or panels), the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a CSI report module 816. The CSI report module 816 may be implemented via hardware, software, or combinations thereof. For example, the CSI report module 816 may be implemented as a processor, circuit, and/or instructions 808 stored in the memory 806 and executed by the processor(s) 804. In some examples, the CSI report module 816 may be integrated within the processor(s) 804 and/or the transceiver(s) 810. For example, the CSI report module 816 may be implemented by a combination of software components (e.g., executed by a DSP or a general processor) and hardware components (e.g., logic gates and circuitry) within the processor(s) 804 or the transceiver(s) 810.

The CSI report module 816 may be used for various aspects of the present disclosure, for example, aspects of the method 500 shown in FIG. 5.

The network device 818 may include one or more processor(s) 820. The processor(s) 820 may execute instructions such that various operations of the network device 818 are performed, as described herein. The processor(s) 820 may include one or more baseband processors implemented using, for example, a central processing unit, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more), which may also be referred to herein as antenna panels or simply panels. In embodiments having multiple antenna(s) 828 (or panels), the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a CSI report module 832. The CSI report module 832 may be implemented via hardware, software, or combinations thereof. For example, the CSI report module 832 may be implemented as a processor, circuit, and/or instructions 824 stored in the memory 822 and executed by the processor(s) 820. In some examples, the CSI report module 832 may be integrated within the processor(s) 820 and/or the transceiver(s) 826. For example, the CSI report module 832 may be implemented by a combination of software components (e.g., executed by a DSP or a general processor) and hardware components (e.g., logic gates and circuitry) within the processor(s) 820 or the transceiver(s) 826.

The CSI report module 832 may be used for various aspects of the present disclosure, for example, aspects of the method 600 shown in FIG. 6.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) configured for multi-panel physical uplink shared channel (PUSCH) transmission using multiple antenna panels, the method comprising:
reporting, from the UE to a base station, a UE capability to indicate a plurality of channel state information (CSI) report schemes supported by the UE;
processing, at the UE, a signal from the base station to configure the UE for a selected CSI report scheme of the plurality of CSI report schemes;
determining, at the UE, whether one or more condition associated with the selected CSI report scheme is satisfied; and
transmitting, from the UE to the base station, CSI in one or more PUSCH from one or more of the multiple antenna panels based on whether the one or more condition associated with the selected CSI report scheme is satisfied.

2. The method of claim 1, further comprising:
if the one or more condition is satisfied, using the selected CSI report scheme to transmit the CSI to the base station based on the multi-panel PUSCH transmission; and
if the one or more condition is not satisfied, falling back to a first CSI report scheme that reports the CSI in a single beam from a single antenna panel of the multiple antenna panels or not reporting the CSI based on the multi-panel PUSCH transmission.

3. The method of claim 2, wherein the first CSI report scheme is independent of the one or more condition, and wherein the one or more condition is selected from a group comprising:
a duration of corresponding PUSCH transmission occasions with the CSI is the same;
a frequency domain resource for the corresponding PUSCH transmission occasions with the CSI is the same;
no uplink control information (UCI) other than the CSI is multiplexed;
the selected CSI report scheme is applicable to a PUSCH multiplexing scheme configured for the UE;
the selected CSI report scheme is applicable to a scheduling operation configured for the UE to schedule the one or more PUSCH;
the selected CSI report scheme is applicable to a transport block (TB) transmission scheme configured for the UE to transmit the one or more PUSCH to carry one TB or TB repetitions; and
the selected CSI report scheme is applicable to a time domain reporting type configured for the UE.

4. The method of claim 2, wherein for the first CSI report scheme and for a single downlink control information (single-DCI) scheduling of the multi-panel PUSCH transmission, the method further comprises selecting a selected PUSCH for reporting the CSI based on one or more option selected from a group comprising:
the selected PUSCH corresponds to a first indicated transmission configuration indicator (TCI) or a last indicated TCI;
the selected PUSCH corresponds to a selected TCI with a lowest identifier (ID) or a highest ID;
the selected PUSCH starts earliest;
the selected PUSCH is transmitted in a lowest frequency location or a highest frequency location;
the selected PUSCH is indicated to the UE from the base station by downlink control information;
the selected PUSCH corresponds to a lower modulation and coding scheme (MCS) or a higher MCS; and
the selected PUSCH corresponds to an uplink transmission without a power limitation and power scaling.

5. The method of claim 2, wherein for the first CSI report scheme and for multiple downlink control information (multi-DCI) scheduling of the multi-panel PUSCH transmission, the method further comprises selecting a selected PUSCH for reporting the CSI based on one or more option selected from a group comprising:
the selected PUSCH corresponds to a first control resource set (CORESET) pool index or a last CORESET pool index;
the selected PUSCH corresponds to a transmission configuration indicator (TCI) with a lowest identifier (ID) or a highest ID;
the selected PUSCH starts earliest;
the selected PUSCH is transmitted in a lowest frequency location or a highest frequency location;
the selected PUSCH corresponds to a scheduling physical downlink control channel (PDCCH) that starts earliest or ends latest;
the selected PUSCH corresponds to a smallest offset Z or a smallest offset Z′, wherein the offset Z is between a last symbol of the PDCCH and a first symbol of a CSI report, and wherein the offset Z′ is between a last symbol of a channel measurement resource (CMR) or an interference measurement resource (IMR) and the first symbol of the CSI report;
the selected PUSCH corresponds to a largest offset Z or a largest offset Z′; and
the selected PUSCH is indicated to the UE from the base station by downlink control information.

6. The method of claim 2, wherein for the first CSI report scheme and for rate matching of the CSI reported in the one or more PUSCH, the method further comprising performing a rate matching operation,
wherein the rate matching operation is based on a selected PUSCH transmission occasion with a CSI report, with N PUSCH transmission occasions carrying N CSI repetitions for one transport block (TB) or different TBs with a same TB size, or
wherein the rate matching operation is based on the N PUSCH transmission occasions to carry one TB including a selected TB with the CSI report.

7. The method of claim 2, wherein for the first CSI report scheme, the method further comprises:
determining an offset Z and an offset Z′ based on a first symbol of a PUSCH transmission occasion with a CSI report, wherein the offset Z is between a last symbol of a physical downlink control channel (PDCCH) and the first symbol of the PUSCH transmission occasion with the CSI report, and wherein the offset Z′ is between a last symbol of a channel measurement resource (CMR) or an interference measurement resource (IMR) and the first symbol of the PUSCH transmission occasion with the CSI report; or
determining the offset Z and the offset Z′ based on a first symbol of the multi-panel PUSCH.

8. The method of claim 2, wherein for the first CSI report scheme:
a CSI processing unit (CPU) is occupied until a last symbol of a PUSCH transmission occasion with a CSI report; or
the CPU is occupied until a last symbol of the multi-panel PUSCH.

9. The method of claim 2, wherein a second CSI report scheme comprises reporting the CSI as N repetitions in N PUSCHs from N antenna panels, and wherein each of the N repetitions of the CSI is reported in one beam from one of the N antenna panels.

10. The method of claim 9, wherein for the second CSI report scheme, the method further comprises determining a same number of coded bits for the N repetitions for rate matching to support soft combining.

11. The method of claim 10, wherein the same number of coded bits is predefined.

12. The method of claim 9, wherein for the second CSI report scheme, the method further comprising:
determining a different number of coded bits for the N repetitions for rate matching; and
in response to determining the different number of coded bits, falling back to the first CSI report scheme or not reporting the CSI.

13. The method of claim 9, wherein for the second CSI report scheme and for a single downlink control information (single-DCI) scheduling of the multi-panel PUSCH transmission, the method further comprises:
determining an offset Z and an offset Z′ based on a first symbol of a PUSCH transmission occasion with a CSI report that starts earlier, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion.

14. The method of claim 13, wherein for the second CSI report scheme:
a CSI processing unit (CPU) is occupied until a last symbol of the PUSCH transmission occasion with the CSI report; or
the CPU is occupied until a last symbol of the multi-panel PUSCH.

15. The method of claim 9, wherein for the second CSI report scheme and for multiple downlink control information (multi-DCI) scheduling of the multi-panel PUSCH transmission, the method further comprises:
determining an offset Z and an offset Z′ based on a last symbol of a first DCI that ends later and a first symbol of a PUSCH transmission occasion with a CSI report that starts earlier, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion.

16. The method of claim 15, wherein for the second CSI report scheme:
a CSI processing unit (CPU) is occupied from second DCI that starts earlier until a last symbol of the PUSCH transmission occasion with the CSI report; or
the CPU is occupied until a last symbol of the multi-panel PUSCH.

17. The method of claim 2, wherein a third CSI report scheme comprises reporting the CSI as one repetition in N PUSCHs from N antenna panels.

18. The method of claim 17, wherein for the third CSI report scheme, rate matching for the CSI is based on the N PUSCHs with the CSI, and wherein the method further comprises:
determining a number of coded bits for the rate matching as a sum of coded bits calculated based on each PUSCH; or
determining the number of coded bits for the rate matching based on a rate matching operation across the N PUSCHs.

19. The method of claim 17, wherein for the third CSI report scheme, the method further comprises:
determining an offset Z and an offset Z′ based on a first symbol of a PUSCH transmission occasion with a CSI report, wherein the offset Z is between a last symbol of a physical downlink control channel (PDCCH) and the first symbol of the PUSCH transmission occasion, and wherein the offset Z′ is between a last symbol of a channel measurement resource (CMR) or an interference measurement resource (IMR) and the first symbol of the PUSCH transmission occasion; or
determining the offset Z and the offset Z′ based on a first symbol of the multi-panel PUSCH.

20. The method of claim 19, wherein for the third CSI report scheme:
a CSI processing unit (CPU) is occupied until a last symbol of the PUSCH transmission occasion with the CSI report; or
the CPU is occupied until a last symbol of the multi-panel PUSCH.

21-38. (canceled)
